(19) United States
(12) Patent Application Publication
(10) Pub. No.: US 2009/0146784 A1
(43) Pub. Date: Jun. 11, 2009

(54) Method and System for Variable Power Amplifier Bias in RFID Transceivers

(76) Inventors: Mohammad Soleimani, North Potamac, MD (US); Martin Strzelczyk, New Market, MD (US); Ronald Boschini, Germantown, MD (US); Amit Asthana, Germantown, MD (US)

Correspondence Address: Fay Kaplun & Marcin, LLP/ Motorola, 150 Broadway Suite 702, New York, NY, 10038, US

(21) Appl. No.: 11/953,323

(22) Filed: Dec. 10, 2007

(51) Int. Cl. H04Q 5/22

(52) U.S. Cl. 340/10.1

(57) ABSTRACT

Described are a method, a device, and a system managing power usage. The method includes operating a communication device in a first state, transmitting a forward signal to at least one target, switching from the first state to a second state, and receiving a reverse signal from the at least one target while operating in the second state. The device, operating in at least a first state and a second state, includes a control circuit switching the device from the first state to the second state, an amplifier operating at a current level coordinated with one of the first state and the second state, and an antenna transmitting a forward signal to at least one target while the device operates in the first state and receiving a reverse signal from the at least one target while the device operates in the second state.

### FIELD OF INVENTION

The present application generally relates to systems and methods for managing the power usage of a radio frequency identification (“RFID”) reader while in communication with an RFID tag. Specifically, the system and methods may allow a radio frequency (“RF”) controller within an RFID reader to vary the bias current of a power amplifier (“PA”) based on the transmission activity of the RFID reader in order to preserve power usage by the RFID reader.

### BACKGROUND

RFID technology may be described as systems and methods for non-contact reading of targets (e.g., products, people, livestock, etc.) in order to facilitate effective management of these targets within a business enterprise. Specifically, RFID allows for the automatic identification of targets, storing target location data, and remotely retrieving target data though the use of RFID tags, or transponders. The RFID tags are an improvement over standard bar codes since the tags may have read and write capabilities. Accordingly, the target data stored on RFID tags can be changed, updated and/or locked. Due to the ability to track moving objects, RFID technology has established itself in a wide range of markets including retail inventory tracking, manufacturing production chain and automated vehicle identification systems. For example, through the use of RFID tags, a retail store can see how quickly the products leave the shelves, and gather information on the customer buying the product.

Within an RFID system, the RFID tag may be a device that is either applied directly to, or incorporated into, one or more targets for the purpose of identification via radio signals. A typical RFID tag may contain at least two parts, wherein a first part is an integrated circuit for storing and processing information, as well as for modulating and demodulating a radio signal. The second part is an antenna for receiving and transmitting radio signals including target data. A typical RFID reader may contain a radio transceiver and may be capable of receiving and processing these radio signals from several meters away and beyond the line of sight of the tag.

Passive RFID tags may rely entirely on the RFID reader as their power source. These tags are read from a limited range and may have a lower production cost. Accordingly, these tags are typically manufactured to be disposed with the product on which it is placed. Unlike the passive RFID tags, active RFID tags may have their own internal power source, such as a battery. This internal power source may be used to power integrated circuits of the tag and broadcast the radio signal to the RFID reader. Active tags are typically much more reliable than passive tags, and may be operable at a greater distance from the RFID reader. Active tags contain more hardware than passive RFID tags, and thus are more expensive.

### SUMMARY OF THE INVENTION

The present invention relates to a method, a device, and a system managing power usage. The method includes operating a communication device in a first state, transmitting a forward signal to at least one target, switching from the first state to a second state, and receiving a reverse signal from the at least one target while operating in the second state. The device, operating in at least a first state and a second state, includes a control circuit switching the device from the first state to the second state, an amplifier operating at a current level coordinated with one of the first state and the second state, and an antenna transmitting a forward signal to at least one target while the device operates in the first state and receiving a reverse signal from the at least one target while the device operates in the second state.

### BRIEF DESCRIPTION OF THE DRAWINGS

FIG. 1 shows an exemplary system for communicating between an exemplary RFID reader and an exemplary RFID tag according to the exemplary embodiments of the present invention.

FIG. 2 shows an exemplary embodiment of the circuitry within the exemplary RFID reader according to the exemplary embodiments of the present invention.

FIG. 3 shows an exemplary power amplifier bias state diagram and characteristic table according to the exemplary embodiments of the present invention.

FIG. 4 shows an exemplary method for managing the PA bias state of the RF controller within an RFID reader according to the exemplary embodiments of the present invention.

### DETAILED DESCRIPTION

The present invention may be further understood with reference to the following description of exemplary embodiments and the related appended drawings, wherein like elements are provided with the same reference numerals. The present invention is related to systems and methods used for improved power performance within a radio frequency identification (“RFID”) reader. Specifically, the exemplary embodiments of the present invention are related to systems and methods for coordinating the bias level of a power amplifier (“PA bias”) within a radio frequency (“RF”) controller within an RFID reading device, such that power, or current draw, may be conserved during intervals in which a high degree of bias may be wasteful.

According to the exemplary embodiments of the present invention, the exemplary systems and methods offer the ability to manage the PA bias of the RFID reader in order to significantly reduce the power draw of the RFID reader when a high PA bias current in not necessary. In other words, the RFID reader may utilize variable PA bias states in the RFID transceiver, wherein the states may be temporally linked to the transmission activity of the transceiver. The management of the PA bias may be accomplished through the selection of two or more PA bias states, such as a transmission state and a reception state. However, it should be noted that while the exemplary systems and methods described herein discuss the use of two bias states, the present invention is not limited to only two states. Accordingly, the exemplary embodiments may have several discrete states, or even have continuously variable bias states. As will be described below, the PA within the RFID reader may switch from a high linearity mode to a Class F mode.

Furthermore, the exemplary embodiments of the present invention allow for improved utility of RFID readers within a mobile device. Those skilled in the art will understand that the RFID readers according to the present invention may also be used to describe RFID readers within any type of electronic device in accordance with the principles and functionality described herein. Thus, the use of a mobile RFID reader is only exemplary.

The radio transceiver of typical RFID systems does not make efficient use of its power. For one reason, the typical RFID reader may provide power via RF energy to passive RFID tags, and the RF carrier for both active and passive RFID tags. As such, the typical RFID reader necessitates transmitting with at least the minimum required power level, dictated by performance requirements, in order to provide the physical energizing for the RFID system. Thus, this minimum power level is used both when the typical RFID transceiver is transmitting a radio signal and receiving a radio signal. Furthermore, a power amplifier (“PA”) of the typical RFID reader may operate with a large amount of bias current in order to maintain good linearity. Stringent RF output regulations may require the RFID reader to operate within a defined level of radio transmission. Thus, good linearity may permit the RFID reader to transmit modulated RF energy cleanly, with negligible noise. Accordingly, this large amount of bias current further increases the demand for power by the RFID system.

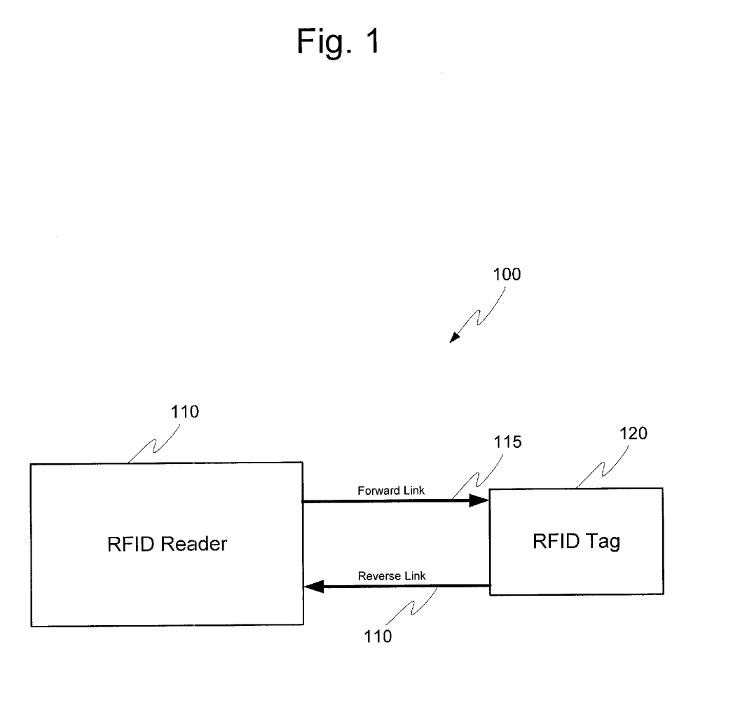

FIG. 1 shows an exemplary system 100 for communicating between an exemplary RFID reader 110 and an exemplary RFID tag 120 according to the exemplary embodiments of the present invention. The exemplary system 100 may be a half-duplex RFID system, wherein the RFID reader 110 and the RFID tag may not modulate simultaneously. Thus, while the exemplary system allows for two-way communication between the RFID reader 110 and the RFID tag 120, this communication may not take place at the same time. Furthermore, this two-way communication may consist of a forward link 115, from the RFID reader 110 to the RFID tag 120, and a reverse link 125, from the RFID tag 120 back to the RFID reader 110. While the exemplary RFID tag 120 described herein may refer to a single tag, it should be noted that the exemplary embodiments of the present invention allow for the RFID reader 110 to be in communication with a plurality of RFID tags.

As described above, the half-duplex data transmissions of the exemplary system 100 allows for data to be transmitted in both directions on a signal carrier, but not at the same time. Accordingly, using a technology that has half-duplex transmission, the RFID reader 110 sends data to the RFID tag 120 via the forward communication link 115, and then immediately receives data from the RFID tag 120 via the reverse communication link 125. It should be noted that while transmitting from the RFID reader 110 to the RFID tag 120 over the forward link 115, the linearity of the PA may be of greater importance than when the RFID tag 120 transmits to the RFID reader 110 over the reverse link 125. Specifically, the PA may operate with a larger amount of PA bias current in order to maintain good linearity. Good linearity may allow for the RFID reader 110 to transmit modulated RF energy more cleanly (e.g., with little interference).

Linearity may be described as the behavior of a circuit, such the PA, wherein an output signal strength varies in direct proportion to the input signal strength. In a linear component, the output-to-input signal amplitude ratio may generally remain the same, regardless of the strength of the input signal. In an amplifier that exhibits linearity, such as the PA of the exemplary system 100, the output-versus-input signal amplitude may be graphed as a straight line. According to the exemplary embodiments of the present invention, good linearity of the PA may allow for the RFID reader 110 to operate with specific RF output regulations (e.g., spectral masks). These spectral masks may be a stringently defined set of parameters applied to the levels of radio transmissions. Accordingly, a spectral mask may reduce RF interference by limiting any excessive radiation at frequencies beyond the defined parameters. The parameters of the spectral masks may be defined and enforced by a regulatory agency, such as the Federal Communications Commission (“FCC”).

While transmitting from the RFID reader 110 to the RFID tag 120 along the forward communication link 115, the PA linearity may be of primary importance. This may be due to the fact that while the forward link 115 is active, the RF output of the RFID reader 110 is spread by modulation. Thus, in order to maintain good PA linearity during the forward link 115, a greater amount of PA bias current may be required. However, when the RFID tag 120 communicates back to the RFID reader 110 over the reverse link 125, it may not be as important to have a high degree of PA linearity. This is due to the fact that when receiving on the reverse link 125 from the RFID tag 120, the RFID reader 110 may only be transmitting RF energy in a continuous wave, and thus this RF energy may be inherently confined in its RF spectrum. Since PA linearity need not be maintained while the reverse link 125 is active, the RFID reader 110 may not expend the greater amount of PA bias current needed to maintain this linearity. Thus, the PA of the exemplary RFID reader 110, according to the exemplary embodiments of the present invention, may be devised so that a high PA bias current is maintained when high linearity is needed (e.g., while the forward link 115 is active). Conversely, the PA may be further devised so that a lower PA bias current is maintained when high linearity is not necessary (e.g., while the reverse link 125 is active). These temporally linked variations in the PA bias may thereby conserve significant amounts of power during the operating of the RFID reader 110.

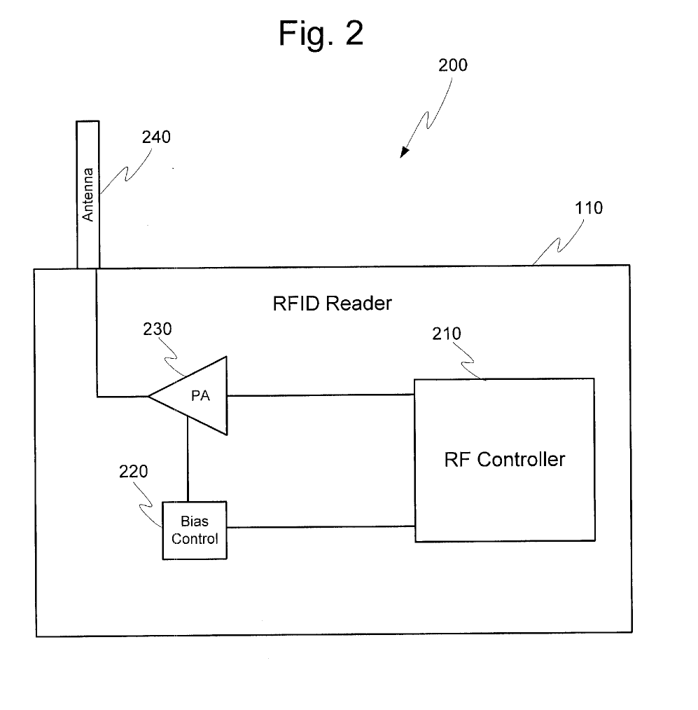

FIG. 2 shows an exemplary embodiment of the circuitry 200 within the exemplary RFID reader 110 according to the exemplary embodiments of the present invention. As described above, the RFID reader 110 may include circuitry 200 that actively adjusts the PA bias current depending transmissions performed by the RFID reader 110. Specifically, the RFID reader 110 may include an RF controller 210, a PA bias circuit 220, a power amplifier (“PA”) 230, and an antenna 240. Specifically, the RF controller 210 may transmit a signal to the PA 230 for transmission via the antenna 240. This circuitry 200 may allow for the PA bias circuit 220 to receive a bias control signal to be received from the RF controller 210 of the RFID reader 110. Based upon this signal, the PA bias circuit 220 may adjust the amount of bias to the PA 230 prior to the signal reaching the antenna 240. Accordingly, the RFID reader 110 may conserve power during any intervals in which a high degree of PA bias may be wasteful (e.g., unnecessary).

According to the exemplary embodiment of the present invention, the PA bias circuit 220 may perform the switching between a high bias current state to a low bias current state very quickly. As described above, the switching between the bias current states may be synchronous with the switching between the forward communication link 115 and the reverse communication link 125. It should be noted that the switching between states may be performed without creating any unintentional spurious emissions from the RFID reader 110, as these emissions may violate certain RF regulatory specification. Furthermore, these emissions may also induce failures in communication between the RFID reader 110 and the RFID tag 120. While the low bias current state may increase internal noise within the RFID reader 110, the exemplary embodiments of the present invention may constrain this noise such that the operation of the antenna 240 (e.g., the receiver) is not adversely effected.

In order to perform a switch between bias current states while limiting the creation of any spurious emissions, the output signal from the RFID reader 110 may be maintained at a near-constant intensity, as well as the frequency and the phase of this signal. Specifically, the signal frequency may be maintained independently from the PA 230 by a phase lock loop (“PLL”) and/or a frequency synthesizer. It should be noted that the signal phase may be altered by an amplifier phase response due to the biasing changes. Accordingly, any rapid change in the phase may result in some loss of spectral purity. However, this noise may be contained well below that which occurs from modulation. Furthermore, an RFID tag having envelope detectors may not “observe” this signal.

Due to its significance in the forward link 115, the intensity of the output signal from the RFID reader 110 may be maintained as constant as possible. According to one exemplary embodiment, the output signal may be maintained by supplying a pre-distorted version of the input signal to the PA stage. This distortion may contain compensation that offsets the change in transfer function of the PA 230 that results from the change in PA bias state. This method may imply an accurate a-priori characterization of this transfer function. According to a further exemplary embodiment, the output signal may be maintained by devising a feedback mechanism to a pre-amplifier stage. This pre-amplified signal may actively compensate the input signal to the PA stage in a closed loop.

Furthermore, according to an additional exemplary embodiment of the present invention, it may be possible to switch the PA bias current during the course of a single communication symbol. This may be possible wherein a RF link protocol of the RFID reader 110 is interval based. Specifically, there may be pulses of modulation that transmit data by being spaced apart into significant intervals. The antenna 240 may be transmitting at a continuous wave during the intervals that do not carry data (e.g., between the significant intervals that actually carry data). Thus, the exemplary methods and systems described herein may be applied at an even lower level of granularity, such as at the communications symbol level.

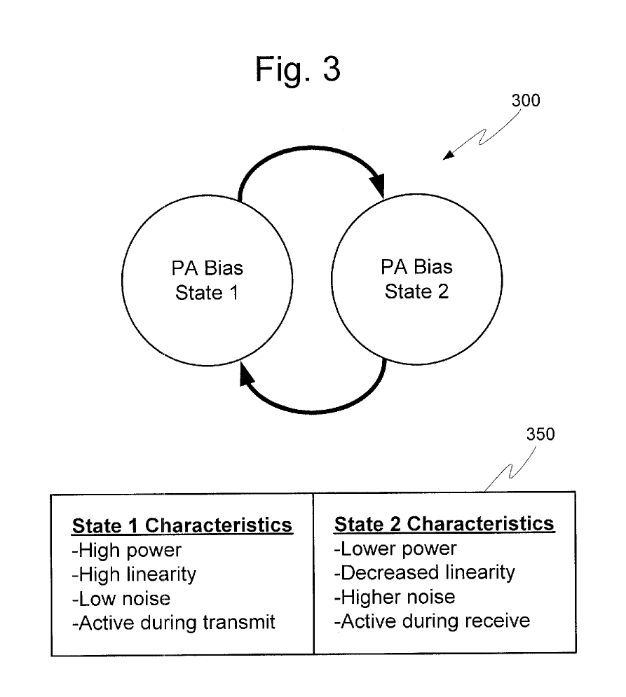

FIG. 3 shows an exemplary PA bias state diagram 300 and characteristic table 350 according to the exemplary embodiments of the present invention. The exemplary diagram 300 and table 350 will be described with reference to the exemplary system 100 of FIG. 1 and the exemplary circuitry 200 of FIG. 2. Accordingly, as illustrated in the diagram 300, the RF controller 210 of the RFID 110 may coordinate the bias level by transitioning from a first bias state to a second bias state. As described above, this transition between bias states may be a quick and efficient transition to avoid any potential problems in maintaining the communication between the RFID reader 110 and the RFID tag 120.

It should be noted that while the diagram 300 depicts two separate PA bias states, the exemplary embodiments of the present invention are not limited to only two states. In other words, the PA bias circuit 220 may allow for multiple discrete bias states, or even allow for continuously variable bias current. Furthermore, the PA bias current 220 may allow the PA 230 to transition from a high linearity mode (e.g., the first bias state) to a Class F amplifier mode. The Class F amplifier mode may be achieved by utilizing a harmonic processing circuit of the PA 230 in order to increase power efficiency in the PA 230. Specifically, the Class F amplifier mode may be characterized by a load network having resonances at one or more harmonic frequencies, in addition to a carrier frequency. The Class F amplifier mode of the PA 230 may use a transistor operating as a current source or a saturating current source. Accordingly, the Class F amplifier mode may not amplify a signal linearly. The Class F amplifier mode may be essentially biased off and may strongly flatten the signal, thereby introducing large amounts of inter-modulation distortion. Thus, the Class F amplifier mode may be described as not linear. In addition, the Class F amplifier mode of the PA 230 may not amplify low power signals. The Class F amplifier mode may further utilize a radio frequency choke, which allows undesirable radio frequency harmonics to travel unfiltered through the PA 230.

The accompanying table 350 describes the characteristics for the first and second PA bias states of the diagram 300. Specifically, the first PA bias state may be active during transmission from the RFID reader 110. Furthermore, as described above, the first PA bias state may be characterized by having high power (e.g., high bias current) and high linearity. As such, the first PA bias state may exhibit relatively low noise. Conversely, the second PA bias state may be active during reception from the RFID tag 120. As described above, the second PA bias state may be characterized by having low power (e.g., low bias current) and low linearity. Accordingly, the second PA bias state may exhibit relatively higher noise while allowing for a significant conservation of power used by the RFID reader 110.

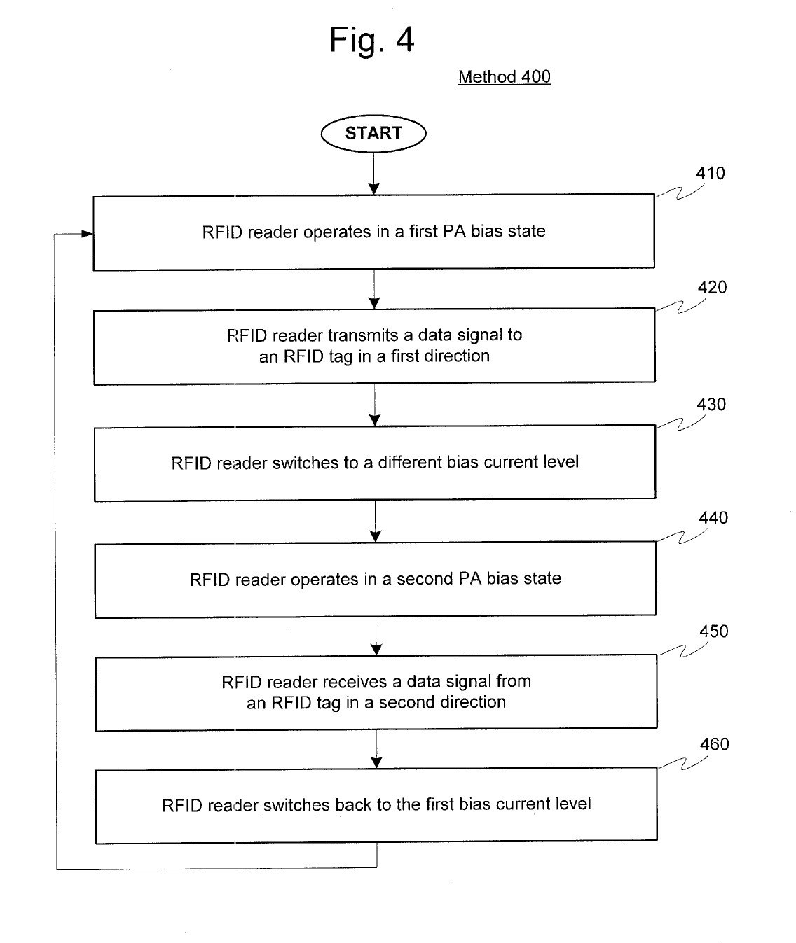

FIG. 4 shows an exemplary method 400 for managing the PA bias state of the RF controller 210 within an RFID reader 110 according to the exemplary embodiments of the present invention. The exemplary method 300 will be described with reference to the exemplary system 100 of FIG. 1. While typical RFID reader radio transceivers maintain a single, relatively high power level during both the transmission and the reception of a radio signal, the RFID reader 110 according to the exemplary embodiments of the present invention may vary the PA bias current of the RFID reader 110 for power saving, wherein the PA bias current is linked to transmission activity on the RFID reader 110.

In step 410, the exemplary RFID reader 110 may operate in a first PA bias state. As described above, this first state may be characterized by a high bias current state in order to achieve a high degree of PA linearity when the RFID reader 110 communicates with the RFID tag 120. The high PA linearity may allow the RFID reader 110 to transmit modulated RF energy cleanly, with little noise.

In step 420, the RFID reader 110 may transmit a data signal (e.g., modulated RF energy) to the RFID tag 120 in a first direction. As described above, this first direction may be communication across the forward link 115, towards the RFID tag 120. Furthermore, since the transmission of the data signal from the RFID reader 110 may be spread by modulation, it may be important to maintain this high degree of PA linearity as data is transferred across the forward link 115. Thus, while the RFID reader 110 operates in the first PA bias state and transmits data across the forward link 115, the RFID reader 110 may be highly linear.

In step 430, the RFID reader 110 may switch to a different bias current level, thereby allowing the RFID reader 110 to operate in a second PA bias state. Specifically, the RF controller 210 may transmit a bias control signal to instruct the PA bias circuit 220 to adjust the bias current level. The PA bias circuit 220 may then communicate this adjustment to the PA 230. The switch from the first PA bias state to the second PA bias state may be temporally connected to a switch from communicating over the forward link 115 and the reverse link 125. Furthermore, this switch may be performed quickly, as to prevent any failures in communication between the RFID reader 110 and the RFID tag 120. In other words, the switching between bias current level may be temporally associated with a switch from a transmission mode of the RFID reader 110 to a receiving mode of the RFID reader 110.

In step 440, the exemplary RFID reader 110 may operate in the second PA bias state. In contrast to operating in the first PA bias state, this second state may be characterized by a lower bias current state. As described above, a high degree of PA linearity is not necessary when the RFID reader 110 receives communication from the RFID tag 120. This lower bias current state may increase the internal noise in the RFID reader 110. However, this noise may be constrained to prevent any negative impact on the operation of the RFID reader 110, such as to the antenna 240.

In step 450, the RFID reader 110 may receive a data signal from the RFID tag 120 in a second direction. As described above, this second direction may be communication across the reverse link 125, from the RFID tag 120. While the reverse link 125 is active, the RFID reader 115 may be transmitting continuous wave RF energy confined to a small spectrum range. While the RFID reader 110 is confined to this spectrum range, it is not important for the RFID reader 110 to maintain high PA linearity. Thus, the PA bias power current may be significantly lower while the RFID reader 110 is operating in the second PA bias state.

In step 460, the RFID reader 110 may switch back to the first bias current level, thereby allowing the RFID reader 110 to operate in the first PA bias state. Specifically, the RF controller 210 may transmit a bias control signal to instruct the PA bias circuit 220 to adjust the bias current level. As described above, the method 400 may not be limited to only two PA bias states. Accordingly, the PA bias circuit 220 may be set to multiple discrete bias states, or simply may be continuously variable.

The exemplary methods and systems described herein may allow for selective power management of the RFID reader 110. In operation, the RFID reader 110 may be a mobile computing device of a manageable size, such a handheld computer. Accordingly, the significant reduction of current draw (e.g., power usage) allowed by the exemplary embodiments of the present invention may significantly improve the power efficiency of such devices, thereby lengthening the time of operation for these devices within a business enterprise.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
operating a communication device in a first state;
transmitting a forward signal to at least one target;
switching from the first state to a second state; and
receiving a reverse signal from the at least one target while operating in the second state.

2. The method according to claim 1, further comprising:
switching from the second state to one of the first state and a further state.

3. The method according to claim 1, wherein the first state is high bias state having a higher current level than the second state.

4. The method according to claim 1, wherein the transmitting of the forward signal maintains a substantially constant intensity level.

5. The method according to claim 1, wherein the second state is a Class F amplifier mode.

6. The method according to claim 1, wherein the switching is synchronous with a switch from a transmission mode to a receiving mode.

7. The method according to claim 1, wherein a power amplifier within the communication device maintains a higher degree of linearity while the forward signal is transmitted than while the reverse signal is received.

8. The method according to claim 1, wherein the switching from the first state to the second state is performed by a bias circuit within the communication device.

9. The method according to claim 1, wherein the communication device is a radio frequency identification reader and the at least one target is a radio frequency identification tag.

10. A device operating in at least a first state and a second state, the device comprising:
a control circuit switching the device from the first state to the second state;
an amplifier operating at a current level coordinated with one of the first state and the second state; and
an antenna transmitting a forward signal to at least one target while the device operates in the first state and receiving a reverse signal from the at least one target while the device operates in the second state.

11. The device according to claim 10, further comprising:
a bias circuit providing a current to the amplifier, wherein the bias circuit changes the amount of bias in the current based on a control signal received from the control circuit.

12. The device according to claim 10, the control circuit further switches the device from the second state to one of the first state and a further state.

13. The device according to claim 10, wherein the first state is high bias state having a higher current level than the second state.

14. The device according to claim 10, wherein the forward signal is transmitted at a substantially constant intensity level.

15. The device according to claim 10, wherein the second state is a Class F amplifier mode.

16. The device according to claim 10, wherein the switching by the control circuit is synchronous with a switch the device from a transmission mode to a receiving mode.

17. The device according to claim 10, wherein the amplifier within the device maintains a higher degree of linearity while the forward signal is transmitted than while the reverse signal is received.

18. The device according to claim 10, wherein the communication device is a radio frequency identification reader and the at least one target is a radio frequency identification tag.

19. A system, comprising:
operating means operating a communication device in a first state;
transmitting means transmitting a forward signal to at least one target;
switching means switching from the first state to a second state; and
receiving means receiving a reverse signal from the at least one target while operating in the second state.

20. The system according to claim 19, wherein the switching means further switches from the second state to one of the first state and a further state.

21. The system according to claim 19, wherein the first state is high bias state having a higher current level than the second state.

22. The system according to claim 19, wherein the second state is a Class F amplifier mode.

23. The system according to claim 19, wherein the switching by the switching means is synchronous with a switch from a transmission mode to a receiving mode.

24. The system according to claim 19, wherein a power amplifier within the communication device maintains a higher degree of linearity while the forward signal is transmitted than while the reverse signal is received.

25. The system according to claim 19, wherein the communication device is a radio frequency identification reader and the at least one target is a radio frequency identification tag.
